(19) United States
(12) Patent Application Publication
(10) Pub. No.: US 2018/0053176 A1
(43) Pub. Date: Feb. 22, 2018

(54) Tap And Pair Via Proximity Sensing

(71) Applicant: GOOGLE INC., Mountain View, CA (US)

(72) Inventors: Paridhi Rawat, Bhawani-Mandi (IN); Rohan Laishram, Imphal West (IN); Arjita Madan, New Delhi (IN); Heman Khanna, Hyderabad (IN); Animesh Chatterji, Jaipur (IN)

(21) Appl. No.: 15/374,591

(22) Filed: Dec. 9, 2016

(30) Foreign Application Priority Data
Aug. 19, 2016 (IN) 201641028279

(51) Int. Cl. G06Q 20/32; H04W 4/00; H04W 76/02; H04W 4/02; G06Q 20/40; G06Q 20/38

(52) U.S. Cl. CPC G06Q 20/3278; H04W 4/008; G06Q 20/385; H04W 4/023; G06Q 20/40; H04W 76/02

(57) ABSTRACT

An operator selects an application on a second user computing device to request a data transfer. A user taps a first user computing device to the second user computing device. If either the second user computing device or the first user computing device does not detect an object via a proximity sensor component within a length of time, the respective computing device cancels the data transfer. If the second user computing device detects an object via a proximity sensor component, the second user computing device broadcasts an audio token comprising data. If the first user computing device detects an object via a proximity sensor component, the first user computing device activates a microphone component of the first user computing device and listens for audio tokens broadcast by the second user computing device. The first user computing device and the second user computing device establish a network connection and the first user computing device transmits data to the second user computing device.

### CROSS-REFERENCE TO RELATED APPLICATION

This patent application claims priority to Indian Application No. 201641028279, filed Aug. 19, 2016, and entitled “Tap and Pair Via Proximity Sensing.” The entire contents of the above-identified application are hereby fully incorporated herein by reference.

### TECHNICAL FIELD

The present disclosure relates to pairing computing devices via proximity sensing between the computing devices.

### BACKGROUND

Users in emerging markets need a convenient user experience to transmit data between user computing devices. In the developed world, the tap-and-pair gesture, enabled via near-field communication (“NFC”) in user computing devices makes transmission of data to or from user computing devices seamless. In emerging markets, however, many user computing devices do not have NFC functionality, making them ineligible to benefit from this NFC tap-and-pair gesture. Many user computing devices without NFC functionality comprise a proximity sensor that allows detection of objects nearby the user computing device.

Current applications for tap-and-pair do not provide for pairing two user computing devices via proximity sensing functionality of the devices.

### SUMMARY

Techniques herein provide computer-implemented methods to pair a user computing device with a service provider computing device via proximity sensing and ultrasound communication to process a service request. In an example embodiment, a user initiates service request at a second user computing device and a first user computing device associated with the user is paired to the second user computing device and a data transfer is processed. The operator of the second user computing device selects an application on the second user computing device to initiate a data transfer. In an example embodiment, the second user computing device generates data and transmits the data to a service processing system. The user taps the first user computing device to the second user computing device. If the second user computing device detects an object via a proximity sensor component, the second user computing device broadcasts an audio token comprising a service request identifier and a second user computing device identifier. If the first user computing device detects an object via a proximity sensor component, the first user computing device activates a microphone component of the first user computing device and receives the audio token broadcast by the second user computing device. If either the second user computing device or the first user computing device does not detect an object via a proximity sensor component within a predetermined length of time, the respective computing device cancels the data transfer. In an example embodiment, the first user computing device and the second user computing device establish a network connection and the first user computing device transmits data to the second user computing device. In another example embodiment, the first user computing device communicates the service request identifier and the second user computing device identifier to the service processing system and the service processing system communicates with the first user computing device and processes a service request.

In certain other example aspects described herein, systems and computer program products to pair a user computing device with a service provider computing device via proximity sensing and ultrasound communication to process a service request are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for pairing a user computing device with a merchant computing device via proximity sensing and ultrasound communication to conduct a payment transaction, in accordance with certain example embodiments.

FIG. 2 is a block flow diagram depicting a method for pairing a user computing device with a merchant computing device via proximity sensing and ultrasound communication to conduct a payment transaction, in accordance with certain example embodiments.

FIG. 3 is a block flow diagram depicting a method for registering, by a user, for an account with a payment processing system, in accordance with certain example embodiments.

FIG. 4 is a block flow diagram depicting a method for initiating, by a user, a payment transaction at a merchant computing device, in accordance with certain example embodiments.

FIG. 5 is a block flow diagram depicting a method for pairing a user computing device to a merchant computing device to process a payment transaction, in accordance with certain example embodiments.

FIG. 6 is a block flow diagram depicting a method for pairing a user computing device to a merchant computing device to process a payment transaction, in accordance with certain example embodiments.

FIG. 7 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for pairing a user computing device with a merchant computing device via proximity sensing and ultrasound communication to conduct a payment transaction.

In an example embodiment, a merchant system registers with a payment processing system and installs a payment application on a merchant computing device. A user registers with the payment processing system and enters payment account information into the user account using a payment application. The user initiates a payment transaction at the merchant computing device and the user computing device is paired to the merchant computing device and a transaction is processed. In other example embodiments, the user initiates a request to share data between the user computing device and the merchant computing device, the user computing device is paired to the merchant computing device to share the requested data. For example, a user of a first user computing device may desire to share or receive data comprising files, images, or text with a user of a second user computing device and may tap the first user computing device to the second user computing device to pair the devices and either share data from the first user computing device to the second user computing device and/or receive data from the second user computing device at the first user computing device. In example embodiments where the user initiates a payment transaction at the merchant computing device, the merchant computing device operator selects the payment application on the merchant computing device to initiate transaction. In an example embodiment, the merchant computing device generates a transaction identifier and transmits the transaction identifier and transaction details to the payment processing system. The user taps the user computing device to the merchant computing device. In an example, if the merchant computing device detects the user computing device via proximity sensing, the merchant computing device broadcasts an audio token via ultrasound communication or audible sound communication comprising the transaction identifier and the merchant computing device identifier. In another example, if the merchant computing device detects the user computing device via proximity sensing, the merchant computing device broadcasts a token via Wi-Fi communication, Bluetooth communication, Bluetooth low-energy communication, light or optical communication, or other communication medium or transfer medium comprising the transaction identifier and the merchant computing device identifier. In an example, if the user computing device detects the merchant computing device via proximity sensing, the user computing device activates a microphone component of the user computing device and receives the audio token broadcast by the merchant computing device. In another example, if the user computing device detects the merchant computing device via proximity sensing, the user computing device activates a component of the user computing device capable of receiving the token broadcast by the merchant computing device in a corresponding transfer medium. For example, the transfer medium comprises Wi-Fi communication, Bluetooth communication, Bluetooth lowe-energy communication, light or optical communication, or other appropriate transfer medium. In an example embodiment, the user computing device and the merchant computing device establish a network connection and the user computing device transmits payment account information to the merchant computing device to process a transaction. In another example, the user computing device transmits data to the merchant computing device and/or receives data from the merchant computing device. In an example embodiment, the user computing device and the merchant computing device establish a network connection comprising a different communication medium or transfer medium than the communication medium or transfer medium used to transfer the token from the merchant computing device to the user computing device. In an example embodiment, the token comprises instructions to the user computing device to establish a network connection with the merchant computing device. For example, the token may comprise a request to establish a network connection and a device identifier associated with the merchant computing device, for example, a media access control (“MAC”) address. In this example, the user computing device establishes the network connection between the user computing device and the merchant computing device in accordance with the instructions. In another example embodiment, the user computing device does not establish a network connection with the merchant computing device and the user computing device communicates the transaction identifier and the merchant computing device identifier to the payment processing system and the payment processing system communicates with the user computing device and processes a transaction. In yet another example embodiment, the user computing device communicates data to the merchant computing device comprising files, images, text, or other data. In certain example embodiments, instead of a merchant computing device, the user computing device pairs with another user computing device via proximity sensing and transmits data to the another user computing device.

A merchant system registers with a payment processing system and installs a payment application on a merchant computing device. A user registers with the payment processing system. For example, the user accesses a payment processing system website via a user computing device and registers with the payment processing system. The user downloads a payment application onto the user computing device. The user enters payment account information into a user account using the payment application. The user configures permissions and settings associated with the user account using the payment application.

A user initiates a transaction at a merchant computing device. For example, the user arrives at the merchant computing device. The merchant computing device operator totals items of the user for purchase. The merchant computing device operator asks the user to select a payment option. The user indicates a desire to pay via the payment application. In an example embodiment, the user computing device is paired to the merchant computing device and a transaction is processed. The merchant computing device operator selects the payment application on the merchant computing device to initiate a transaction. The merchant computing device generates a transaction identifier and transmits transaction details, a transaction identifier, and a merchant computing device identifier to a payment processing system. The payment processing system receives the transaction details, the transaction identifier, and the merchant computing device identifier. The user taps the user computing device to the merchant computing device. If the merchant computing device does not detect the user computing device within a threshold length of time, the merchant computing device cancels the transaction after the threshold length of time passes. If the merchant computing device detects the user computing device within the threshold length of time, the merchant computing device broadcasts an audio token comprising the transaction identifier and the merchant computing device identifier. If the user computing device does not detect the merchant computing device, the user computing device cancels the transaction after the threshold length of time passes. If the user computing device detects the merchant computing device within the threshold length of time, the user computing device activates a microphone of the user computing device. The user computing device receives the audio token broadcast by the merchant computing device comprising the transaction identifier and the merchant device identifier. The user computing device communicates the transaction identifier and the merchant computing device identifier to the payment processing system. The payment processing system communicates with the user computing device and processes a transaction.

In another example embodiment, the user computing device is paired to the merchant computing device and a transaction is processed. The merchant computing device operator selects the payment application on the merchant computing device to initiate a transaction. The user taps the user computing device to the merchant computing device. If the merchant computing device does not detect the user computing device within a threshold length of time, the merchant computing device cancels the transaction after the threshold length of time passes. If the merchant computing device detects the user computing device within the threshold length of time, the merchant computing device broadcasts an audio token via ultrasound communication or audible sound communication, comprising the transaction identifier and the merchant computing device identifier. In another example, in response to detecting the user computing device within the threshold length of time, the merchant computing device broadcasts a token via a communication medium comprising Wi-Fi communication, Bluetooth communication, Bluetooth low-energy communication, light communication, or other communication medium. If the user computing device does not detect the merchant computing device, the user computing device cancels the transaction after the threshold length of time passes. If the user computing device detects the merchant computing device within the threshold length of time, the user computing device activates a microphone of the user computing device. In another example, if the user computing device detects the merchant computing device within the threshold length of time, the user computing device activates a corresponding functionality on the user computing device able to receive the token broadcast by the merchant computing device via Wi-Fi communication, Bluetooth communication, Bluetooth low-energy communication, other radio frequency communication, light communication, or other communication medium. For example, if the user computing device detects the merchant computing device within the threshold length of time, the user computing device activates a radio frequency controller and antenna, light detector, and/or other appropriate functionality on the user computing device able to receive data communicated over the communication medium utilized by the merchant computing device. The user computing device receives the audio token broadcast by the merchant computing device comprising the transaction identifier and the merchant device identifier. In another example, the user computing device receives the token broadcast by the merchant computing device comprising the transaction identifier and the merchant device identifier. The user computing device and the merchant computing device establish a network connection. The merchant computing device transmits a request for payment account information or other data to the user computing device. The merchant computing device receives payment account information or other data from the user computing device. In other example embodiments, the user computing device and the merchant computing device do not establish a network connection.

In yet another example embodiment, a first user computing device is paired to a second user computing device and data is transferred and/or shared between the first user computing device and the second user computing device. An operator of the second user computing device selects an application on the second user computing device to initiate a transfer of data. For example, the operator of the second user computing device desires to receive data from the operator of the first user computing device. The data may comprise files, images, text, applications, and/or any other transferable data. The operator of the first user computing device and/or the operator of the second user computing device taps the first user computing device to the second user computing device by moving the first user computing device and/or the second user computing device such that the proximity sensors of the two devices are within a threshold range of the other device. For example, the threshold range is a range within which a proximity sensor of either device may detect the other device. If the second user computing device does not detect the user computing device within a threshold length of time via a proximity sensor of the second user computing device, the second user computing device cancels the data transfer after the threshold length of time passes. If the second user computing device detects the first user computing device within the threshold length of time via the proximity sensor of the second user computing device, the second user computing device broadcasts an audio token via ultrasound communication or audible sound communication, comprising a second user computing device identifier. In another example, in response to detecting the first user computing device within the threshold length of time via the proximity sensor of the second user computing device, the second user computing device broadcasts a token via a communication medium comprising Wi-Fi communication, Bluetooth communication, Bluetooth low-energy communication, light communication, or other communication medium. If the first user computing device does not detect the merchant computing device via a proximity sensor of the first user computing device, the first user computing device cancels the transfer of data after the threshold length of time passes. If the first user computing device detects the second user computing device within the threshold length of time via the proximity sensor of the first user computing device, the first user computing device activates a microphone of the user computing device. In another example, if the first user computing device detects the second user computing device within the threshold length of time via the proximity sensor of the first user computing device, the first user computing device activates a corresponding functionality on the first user computing device able to receive the token broadcast by the second user computing device via Wi-Fi communication, Bluetooth communication, Bluetooth low-energy communication, other radio frequency communication, light communication, or other communication medium. For example, if the first user computing device detects the merchant computing device within the threshold length of time via the proximity sensor of the first user computing device, the first user computing device activates a radio frequency controller and antenna, light detector, and/or other appropriate functionality on the first user computing device able to receive data communicated over the communication medium utilized by the second user computing device. The first user computing device receives the audio token broadcast by the second user computing device comprising the second device identifier. In another example, the first user computing device receives the token broadcast by the second user computing device comprising the second device identifier. The first user computing device and the second user computing device establish a network connection. The second user computing device transmits a request for data to the first user computing device, the first user computing displays a user interface that enables a user of the first user computing device to select one or more data for transmission to the second user computing device, the first user computing device receives an input of a selection of one or more data to transmit to the second user computing device, and the first user computing device transmits the data corresponding to the received selection to the second user computing device. The second user computing device receives the data from the first user computing device selected by the user of the first user computing device. In other example embodiments, the first user computing device and the second user computing device do not establish a network connection.

By using and relying on the methods and systems described herein, the user computing device and the merchant computing device provide the capability to pair via proximity sensing without the necessity of using NFC. Further, the user computing device, the merchant computing device, the payment processing system, and the issuer system enable the user to conduct a transaction at the merchant computing device by pairing the user computing device to the merchant computing device via proximity sensing. As such, the systems and methods described herein may enable pairing of computing devices not comprising conventional NFC functionality or in an environment in which NFC is unavailable.

### Example System Architecture

Turning now to the drawings, in which like numerals indicate like (but not necessarily identical) elements throughout the figures, example embodiments are described in detail.

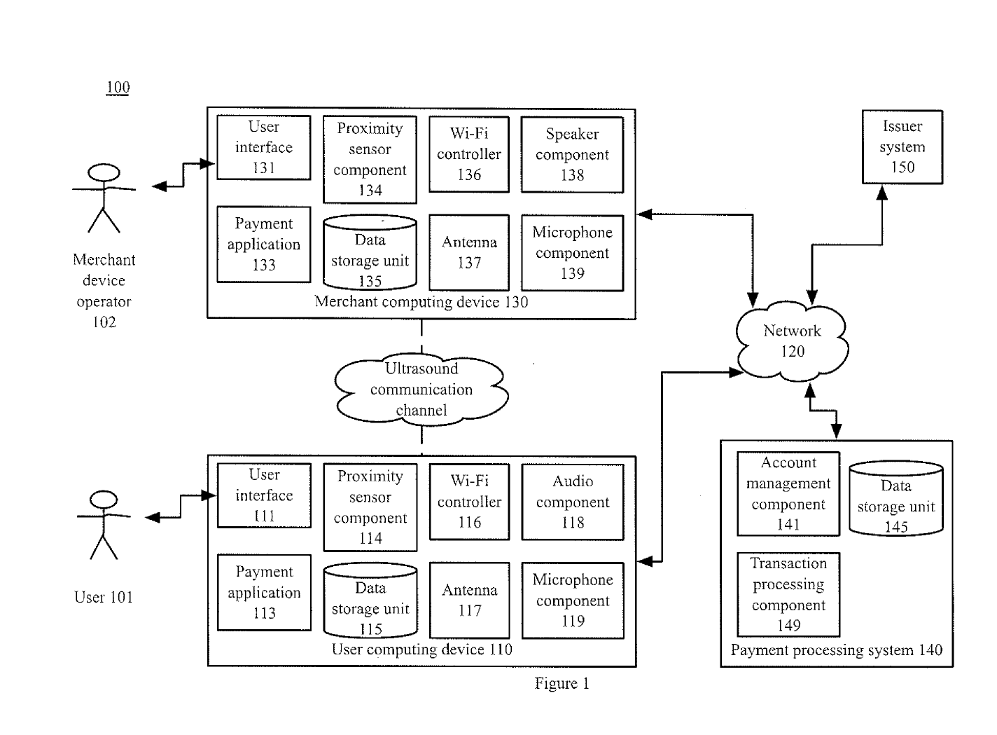

FIG. 1 is a block diagram depicting a system 100 for pairing a user computing device 110 with a merchant computing device 130 via proximity sensing and ultrasound communication to conduct a payment transaction, in accordance with certain example embodiments. As depicted in FIG. 1, the system 100 includes network computing devices 110, 130, 140, and 150 that are configured to communicate with one another via one or more networks 120. In some embodiments, a user associated with a device must install an application and/or make a feature selection to obtain the benefits of the techniques described herein.

In example embodiments, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy (“BLE”), near field communication (“NFC”), ultrasound communication, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, 140, and 150 includes a device having a communication module capable of transmitting and receiving data over the network 120. For example, each network computing device 110, 130, 140, and 150 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 130, 140, and 150 are operated by users 101, merchant computing device operators 102, payment processing system 140 operators, and issuer system 150 operators, respectively.

In certain embodiments, two computing devices comprising a user computing device 110 and a merchant computing device 130 are paired via proximity sensing in response to a tap of the two devices. However, in other example embodiments, a first user computing device 110 and a second user computing device 110 are paired via proximity sensing in response to a tap of the two devices. One or more functions described as being performed by the user computing device 110 may also be performed by a first user computing device 110 and one or more functions described as being performed by the merchant computing device 130 may also be performed by a second user computing device 110.

An example user computing device 110, or first user computing device, comprises a user interface 111, a payment application 113, a proximity sensor component 114, a data storage unit 115, a Wi-Fi controller 116, an antenna 117, an audio component 118, and a microphone component 119.

In an example embodiment, the user interface 111 enables the user 101 to interact with the user computing device 110. For example, the user interface 111 may be a touch screen, a voice-based interface, or any other interface that allows the user 101 to provide input and receive output from an application on the user computing device 110. In an example embodiment, the user 101 interacts via the user interface 111 with the payment application 113.

In an example embodiment, the payment application 113 is a program, function, routine, applet, or similar entity that exists on and performs its operations on the user computing device 110. In certain example embodiments, the user 101 must install the payment application 113 and/or make a feature selection on the user computing device 110 to obtain the benefits of the techniques described herein. In an example embodiment, the user 101 may access the payment application 113 on the user computing device 110 via the user interface 111. In an example embodiment, the payment application 113 may be associated with the payment processing system 140.

In an example embodiment, the proximity sensor component 114 comprises a proximity sensor device capable of detecting objects within a predefined proximity of the proximity sensor device. In an example, the proximity sensor component 114 comprises an infrared proximity sensor. In an example embodiment, the proximity sensor component 114 communicates with the payment application 113, for example, the proximity sensor component 114 transmits an alert to the payment application 113 in response to detecting an object. In another example embodiment, the proximity sensor component 114 transmits instructions to open the payment application 113 in response to detecting an object.

In an example embodiment, the data storage unit 115 comprises a local or remote data storage structure accessible to the user computing device 110 suitable for storing information. In an example embodiment, the data storage unit 115 stores encrypted information, such as HTML5 local storage.

In an example embodiment, the Wi-Fi controller 116 is capable of sending and receiving data, performing authentication and ciphering functions, and directing how the user computing device 110 will listen for transmissions from the merchant computing device 130 or configuring the user computing device 110 into various power-save modes according to Wi-Fi-specified procedures. In another example embodiment, the user computing device 110 comprises a Bluetooth controller, Bluetooth low energy (“BLE”) controller, or an NFC controller capable of performing similar functions. An example Wi-Fi controller 116 communicates with the payment application 113 and is capable of sending and receiving data over a wireless, Wi-Fi communication channel. In another example embodiment, a Bluetooth controller, BLE controller, or NFC controller performs similar functions as the Wi-Fi controller 116 using Bluetooth, BLE, or NFC protocols. In an example embodiment, the Wi-Fi controller 116 activates the antenna 117 to create a wireless communication channel between the user computing device 110 and the merchant computing device 130. For example, the user computing device 110 communicates with the merchant computing device 130 via the antenna 117. In an example embodiment, when the user computing device 110 has been activated, the Wi-Fi controller 116 polls through the antenna 117 a radio signal, or listens for radio signals from the merchant computing device 130.

In an example embodiment, the antenna 117 is a means of communication between the user computing device 110 and a merchant computing device 130. In an example embodiment, a Wi-Fi controller 116 outputs through the antenna 117 a radio signal, or listens for radio signals from the merchant computing device 130. In another example embodiment a Bluetooth controller or a near field communication (“NFC”) controller is used.

In an example embodiment, the audio component 118 comprises a speaker device or other device capable of producing an ultrasound output. In an example embodiment, the audio component 118 can communicate with the payment application 113 to receive an instruction to broadcast an ultrasound output. In an example embodiment, the audio component 118 is a component of the user computing device 110. In another example embodiment, the audio component 118 is communicatively coupled to the user computing device 110.

In an example embodiment, the microphone component 119 comprises a microphone device that is capable of receiving ultrasound inputs from an environment of the user computing device 110. In an example embodiment, the microphone component 119 communicates with the payment application 113 to receive an instruction to transition from a passive mode to an active mode and listen for ultrasound inputs. In an example embodiment, the microphone component 119 receives ultrasound inputs while in the active mode and transmits the received ultrasound inputs to the payment application 113.

An example merchant computing device 130, or second user computing device, comprises a user interface 131, a payment application 133, a proximity sensor component 134, a data storage unit 135, a Wi-Fi controller 136, an antenna 137, an audio component 138, and a microphone component 139. In an example embodiment, the merchant computing device 130 comprises a mobile computing device such as a smartphone device, tablet device, or other mobile computing device. In another example embodiment, the merchant computing device 130 comprises a point of sale terminal.

In an example embodiment, the user interface 131 enables the merchant computing device operator 102 to interact with the merchant computing device 130. For example, the user interface 131 may be a touch screen, a voice-based interface, or any other interface that allows the merchant computing device operator 102 to provide input and receive output from an application on the merchant computing device 130. In an example embodiment, the merchant computing device operator 102 interacts via the user interface 131 with the payment application 133.

In an example embodiment, the payment application 133 is a program, function, routine, applet, or similar entity that exists on and performs its operations on the merchant computing device 130. In certain example embodiments, the merchant computing device operator 102 must install the payment application 133 and/or make a feature selection on the merchant computing device 130 to obtain the benefits of the techniques described herein. In an example embodiment, the merchant computing device operator 102 may access the payment application 133 on the merchant computing device 130 via the user interface 131. In an example embodiment, the payment application 133 may be associated with the payment processing system 140.

In an example embodiment, the proximity sensor component 134 comprises a proximity sensor device capable of detecting objects within a predefined proximity of the proximity sensor device. In an example, the proximity sensor component 134 comprises an infrared proximity sensor. In an example embodiment, the proximity sensor component 134 communicates with the payment application 133, for example, the proximity sensor component 134 transmits an alert to the payment application 133 in response to detecting an object. In certain other example embodiments, the merchant computing device 130 does not comprise a proximity sensor component 134.

In an example embodiment, the data storage unit 135 comprises a local or remote data storage structure accessible to the merchant computing device 130 suitable for storing information. In an example embodiment, the data storage unit 135 stores encrypted information, such as HTML5 local storage.

In an example embodiment, the Wi-Fi controller 136 is capable of sending and receiving data, performing authentication and ciphering functions, and directing how the merchant computing device 130 will listen for transmissions from the user computing device 110 or configuring the merchant computing device 130 into various power-save modes according to Wi-Fi-specified procedures. In another example embodiment, the merchant computing device 130 comprises a Bluetooth controller, Bluetooth low energy (“BLE”) controller, or an NFC controller capable of performing similar functions. An example Wi-Fi controller 136 communicates with the payment application 133 and is capable of sending and receiving data over a wireless, Wi-Fi communication channel. In another example embodiment, a Bluetooth controller, BLE controller, or NFC controller performs similar functions as the Wi-Fi controller 136 using Bluetooth, BLE, or NFC protocols. In an example embodiment, the Wi-Fi controller 136 activates the antenna 137 to create a wireless communication channel between the merchant computing device 130 and the user computing device 110. For example, the merchant computing device 130 communicates with the user computing device 110 via the antenna 137. In an example embodiment, when the merchant computing device 130 has been activated, the Wi-Fi controller 136 polls through the antenna 137 a radio signal, or listens for radio signals from the merchant computing device 130.

In an example embodiment, the antenna 137 is a means of communication between the merchant computing device 130 and the user computing device 110. In an example embodiment, a Wi-Fi controller 136 outputs through the antenna 137 a radio signal, or listens for radio signals from the user computing device 110. In another example embodiment a Bluetooth controller or a near field communication (“NFC”) controller is used.

In an example embodiment, the audio component 138 comprises a speaker device or other device capable of producing an ultrasound output. In an example embodiment, the audio component 138 can communicate with the payment application 133 to receive an instruction to broadcast an ultrasound output. In an example embodiment, the audio component 138 is a component of the merchant computing device 130. In another example embodiment, the audio component 138 is communicatively coupled to the merchant computing device 130.

In an example embodiment, the microphone component 139 comprises a microphone device that is capable of receiving ultrasound inputs from an environment of the merchant computing device 130. In an example embodiment, the microphone component 139 communicates with the payment application 133 to receive an instruction to transition from a passive mode to an active mode and listen for ultrasound inputs. In an example embodiment, the microphone component 139 receives ultrasound inputs while in the active mode and transmits the received ultrasound inputs to the payment application 133.

An example payment processing system 140, or service processing system, comprises an account management component 141, a data storage unit 145, and a transaction processing component 149.

In an example embodiment, the account management component 141 manages user 101 accounts and merchant system accounts associated with users 101 and merchant systems, respectively. The account management component 141 may receive requests to add, edit, delete, or otherwise modify payment account information for a user 101 account or a merchant system account.

In an example embodiment, the data storage unit 145 comprises a local or remote data storage structure accessible to the payment processing system 140 suitable for storing information. In an example embodiment, the data storage unit 145 stores encrypted information, such as HTML5 local storage.

In an example embodiment, the transaction processing component 149 receives transaction details from a merchant computing device 130 and payment information associated with a user 101 payment account. In an example embodiment, the transaction processing component 149 transmits a payment authorization request to an issuer system 150 or other appropriate financial institution associated with the user 101 payment account information. An example payment authorization request may comprise merchant system payment account information, user 101 payment account information, and a total amount of the transaction. In an example embodiment, after the issuer system 150 processes the payment authorization request, the transaction processing component 149 receives an approval or denial of the payment authorization request from the issuer system 150 over the network 120. In an example embodiment, the transaction processing component 149 transmits a receipt to the merchant computing device 130 and/or the user computing device 110 comprising a summary of the payment transaction.

In another example embodiment, the transaction processing component 149 receives a transaction identifier generated by the merchant computing device 130, a merchant computing device 130 identifier, and transaction details from the merchant computing device 130. For example, the transaction details comprise the total amount of the transaction. In an example embodiment, the transaction processing component identifies a merchant system account based on the merchant computing device 130 identifier and identifies a merchant system payment account associated with the merchant system account for use in the transaction. In an example embodiment, the transaction processing component 149 associates the received transaction details, transaction identifier and merchant system payment account information and stores the associated transaction details, transaction identifier, and merchant system payment account information in a data storage unit 145 or other memory accessible by the payment processing system 140. In an example embodiment, the transaction processing component receives the transaction identifier from the user computing device 110. In this example embodiment, the transaction processing component 149 extracts the stored transaction details and merchant system payment account information associated with the transaction identifier. In an example embodiment, the transaction processing component 149 receives a user 101 payment account identifier based on a selection of the user 101 of the particular payment account via the user interface 111 of the user computing device 130. In this example embodiment, the transaction processing component 149 extracts the user 101 payment account information associated with the payment account identifier.

An example issuer system 150 approves or denies a payment authorization request received from the merchant computing system 130 or from the payment processing system 140. In an example embodiment, the issuer system 150 communicates with the merchant computing device 130 and/or payment processing system 140 over the network 120. In an example embodiment, the issuer system 130 communicates with an acquirer system to approve a credit authorization and to make payment to the payment processing system 140 and/or merchant system. For example, the acquirer system is a third party payment processing company.

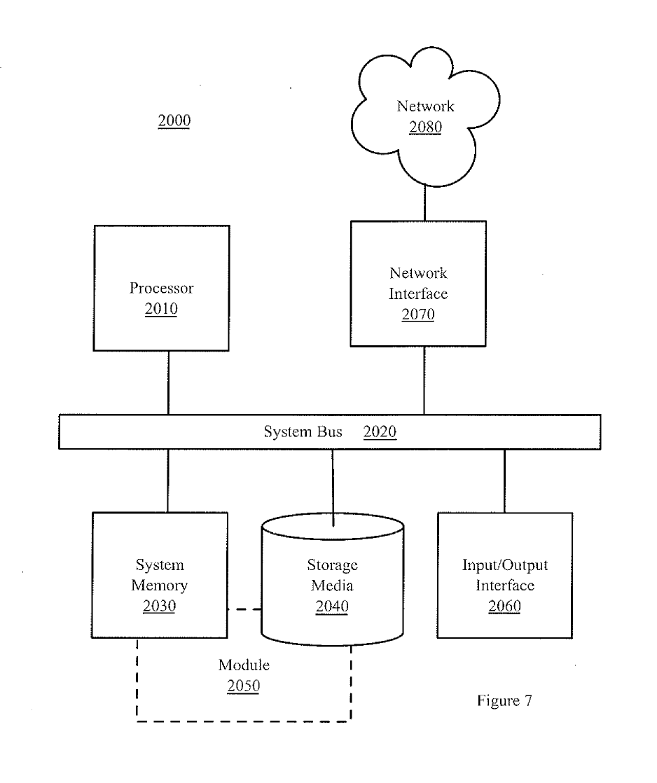

In example embodiments, the network computing devices and any other computing machines associated with the technology presented herein may be any type of computing machine such as, but not limited to, those discussed in more detail with respect to FIG. 7. Furthermore, any functions, applications, or components associated with any of these computing machines, such as those described herein or any others (for example, scripts, web content, software, firmware, hardware, or modules) associated with the technology presented herein may by any of the components discussed in more detail with respect to FIG. 7. The computing machines discussed herein may communicate with one another, as well as with other computing machines or communication systems over one or more networks, such as network 120. The network 120 may include any type of data or communications network, including any of the network technology discussed with respect to FIG. 7.

### Example Processes

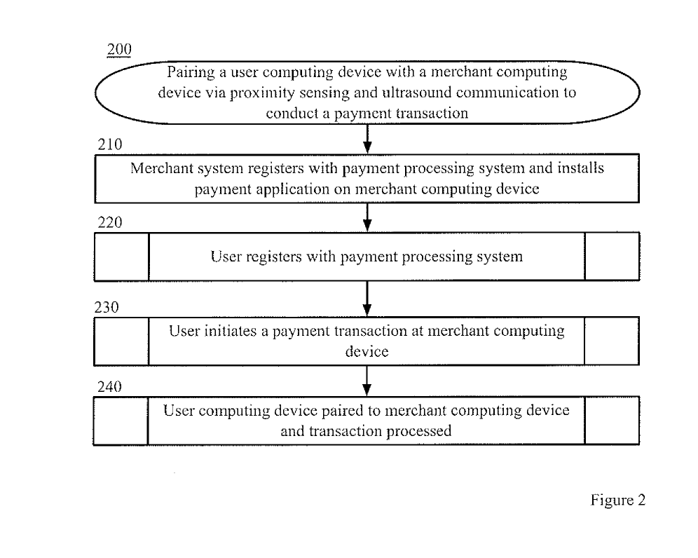

The example methods illustrated in FIGS. 2-6 are described hereinafter with respect to the components of the example operating environment 100. The example methods of FIGS. 2-6 may also be performed with other systems and in other environments. The operations described with respect to any of the FIGS. 2-6 can be implemented as executable code stored on a computer or machine readable non-transitory tangible storage medium (e.g., floppy disk, hard disk, ROM, EEPROM, nonvolatile RAM, CD-ROM, etc.) that are completed based on execution of the code by a processor circuit implemented using one or more integrated circuits; the operations described herein also can be implemented as executable logic that is encoded in one or more non-transitory tangible media for execution (e.g., programmable logic arrays or devices, field programmable gate arrays, programmable array logic, application specific integrated circuits, etc.).

FIG. 2 is a block diagram depicting a method 200 for pairing a user computing device 110 with a merchant computing device 120 via proximity sensing and ultrasound communication to conduct a payment transaction, in accordance with certain example embodiments. The method 200 is described with reference to the components illustrated in FIG. 1.

In block 210, the merchant system registers with the payment processing system 140. In an example embodiment, an agent of the merchant system registers for a merchant account with the payment processing system 140 via a web site of the payment processing system 140. In an example embodiment, a merchant computing device operator 102 installs the payment application 133 on the merchant computing device 130. In another example embodiment, the merchant computing device operator 102 purchases a merchant computing device 130 from the payment processing system 140 or otherwise obtains the merchant computing device 130 with the payment application 133 pre-installed on the merchant computing device 130. In an example embodiment, the merchant computing device 130 is able to communicate with one or more user computing devices 110, the payment processing system 140, one or more issuer systems 150, and one or more acquirer systems over a network 120. In an example embodiment, the merchant computing device 130 communicates with the payment processing system 140 via the payment application 113 over the network 120. In certain example embodiments, the merchant computing device 130 may be able to transmit transaction details and a merchant computing device 130 identifier to the payment processing system 140 via the payment application 113 over the network 120 to enable the payment processing system 140 to process a transaction. In an example embodiment, the merchant computing device 130 is able to receive receipts from the payment processing system 140 that notifies a merchant computing device operator 102 as to whether a transaction was successful or not. In an example embodiment, the merchant computing device 130 comprises a mobile device, for example, a mobile phone device, a tablet device, or a laptop computing device. In another example embodiment, the merchant computing device 130 comprises a point of sale terminal.

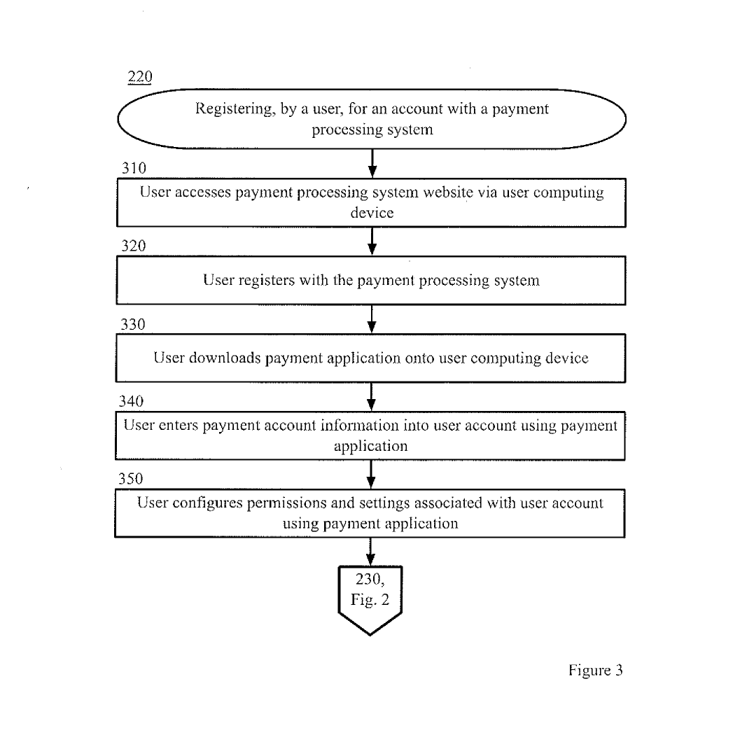

In block 220, the user 101 registers with the payment processing system 140. The method for registering, by a user 101, for an account with a payment processing system 140 is described in more detail hereinafter with reference to the method described in FIG. 3.

FIG. 3 is a block diagram depicting a method 220 for registering, by a user 101, for an account with a payment processing system 140, in accordance with certain example embodiments. The method 220 is described with reference to the components illustrated in FIG. 1.

In block 310, the user accesses a payment processing system 140 website via the user computing device 110. For example, the user 101 accesses the payment processing system 140 website via a web browser of the user computing device 110. In another example, the user 101 may otherwise contact the payment processing system 140 to register for a user 101 account.

In block 320, the user 101 registers with the payment processing system 140. The user 101 may obtain a user 101 account number, receive the appropriate applications and software to install on the user computing device 110 or perform any action provided by the payment processing system 140. The user 101 may utilize the functions of the user computing device 110, such as the user interface 111 and the web browser, to register and configure a user 101 account.

In block 330, the user 101 downloads a payment application 113 onto the user computing device 110. In an example embodiment, the payment application 113 operating on the user computing device 110 is able to communicate with the payment processing system 140 over the network 120.

In block 340, the user 101 enters payment account information into the user 101 account using the payment application 113. In an example embodiment, the user 101 may enter payment account information associated with one or more user 101 accounts, for example, one or more credit accounts, one or more bank accounts, one or more stored value accounts, and/or other appropriate accounts into the user 101 account maintained by the payment processing system 140.

In block 350, the user 101 configures permissions and settings associated with the user 101 account using the payment application 113. In an example embodiment, the user 101 may configure user 101 account settings or add, delete, or edit payment account information via the payment application 113. In an example embodiment, the user 101 may select an option to enable or disable the permission of the payment processing system 140 to process transactions.

From block 350, the method 220 proceeds to block 230 in FIG. 2.

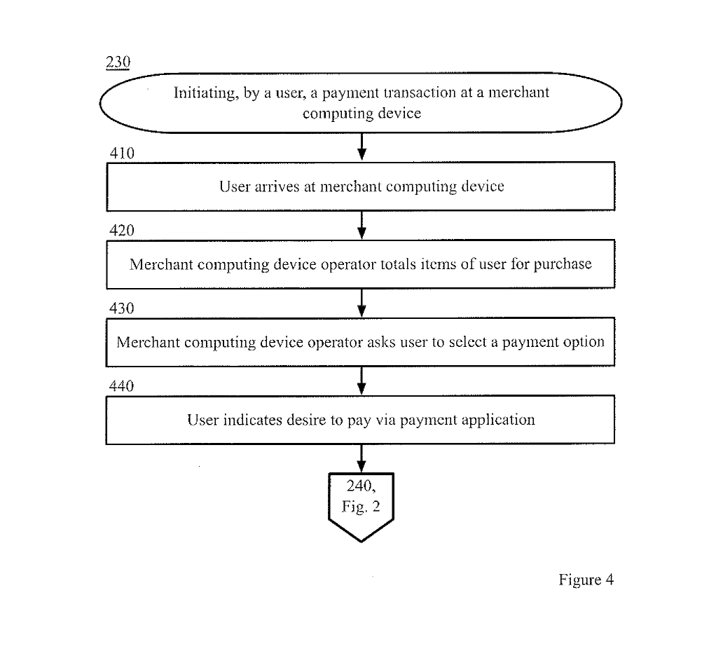

Returning to FIG. 2, in block 230, the user 101 initiates a payment transaction at the merchant computing device 130. The method for initiating, by a user 101, a payment transaction at a merchant computing device 130 is described in more detail hereinafter with reference to the method described in FIG. 4.

FIG. 4 is a block diagram depicting a method 230 for initiating, by a user 101, a payment transaction at a merchant computing device 130, in accordance with certain example embodiments. The method 230 is described with reference to the components illustrated in FIG. 1.

In block 410, the user 101 arrives at the merchant computing device 130. In an example embodiment, at a time prior to approaching the merchant computing device 130, the user 101 browses the merchant system location and selects one or more items to purchase. In this example embodiment, the user 101 may collect the one or more items and carry, or otherwise transport via physical basket or shopping cart, the one or more items to the merchant computing device 130. In this example embodiment, the user 101 carries or otherwise has in his possession the user computing device 110.

In block 420, the merchant computing device operator 102 totals items of the user 101 for purchase. In an example embodiment, the merchant computing device operator 102 scans barcodes associated with the one or more items of the user 101 or otherwise enters information associated with the items into the merchant computing device 130.

In block 430, the merchant computing device operator 102 asks the user 101 to select a payment option. In an example embodiment, the merchant computing device 130 displays one or more payment options that the user 101 may select to use in a transaction. Example payment options may comprise payment via a payment application 133 associated with the payment processing system 140 with which both the user 101 and the merchant system have an account, payment by cash, payment by check, payment by credit card, payment by debit card, and/or any other means of payment that the merchant system can or is willing to accept for payment from the user 101. In an example embodiment, the one or more payment options are displayed as objects on the user interface 131 and are selectable by the merchant computing device operator 102 in response to the user 101 directing the merchant computing device operator 102 to make a selection via the user interface 131 of the merchant computing device 130. In an example embodiment, the merchant computing device operator 102 may ask the user 101 if the user 101 wishes to conduct a transaction using the account of the user 101 associated with the payment processing system 140.

In block 440, the user 101 indicates a desire to pay via the payment application 133. For example, the user 101 directs the merchant computing device operator 102 to initiate a transaction via the payment application 133.

From block 440, the method 230 proceeds to block 240 in FIG. 2.

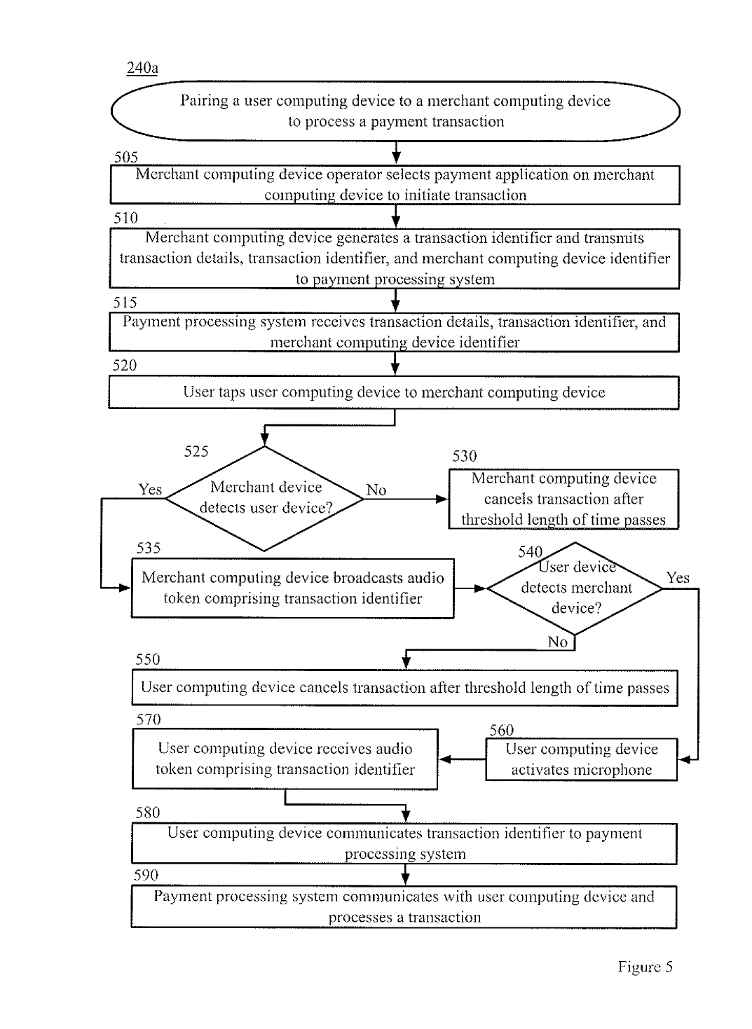

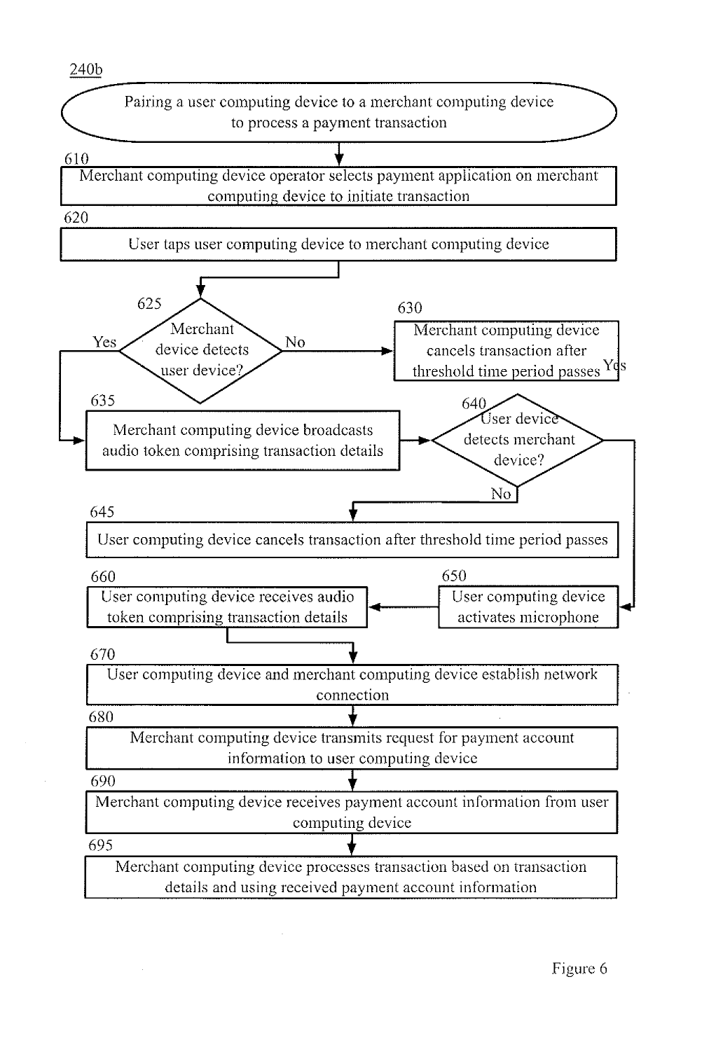

Returning to FIG. 2, in block 240, the user computing device 110 is paired to the merchant computing device 130 and the transaction is processed. Methods for pairing a user computing device 110 to a merchant computing device 130 to process a payment transaction are described in more detail hereinafter with reference to the methods described in FIG. 5 and FIG. 6.

FIG. 5 is a block diagram depicting a method 240a for pairing a user computing device 110 to a merchant computing device 130 to process a payment transaction, in accordance with certain example embodiments. The method 240a is described with reference to the components illustrated in FIG. 1.

In block 505, the merchant computing device operator 102 selects the payment application 133 on the merchant computing device 130 to initiate a transaction. In an example embodiment, in response to receiving a verbal request from the user 101 to select the payment application 133 as a payment option, the merchant computing device operator 102 actuates an object on the user interface 131 of the merchant computing device 130 corresponding to the payment application 133 as a payment option.

In block 510, the merchant computing device 130 generates a transaction identifier and transmits transaction details, a transaction identifier, and a merchant computing device 130 identifier to the payment processing system 140. In an example embodiment, the merchant computing device 130 generates the transaction identifier via a random number generator of the payment application 133. In an example embodiment, the transaction identifier comprises a string of alphanumeric and/or symbolic characters. In an example embodiment, transaction details comprise a total amount for the transaction and/or a listing of the one or more items being purchased by the user 101. In an example embodiment, the merchant computing device 130 identifier comprises a media access control (“MAC”) address, hardware identifier, or other identifier associated with the merchant computing device 130. In this example embodiment, the payment processing system 140 is able to identify a merchant system account based on the merchant computing device 130 identifier. In an example embodiment, the merchant computing device 30 transmits the transaction details, the transaction identifier, and the merchant computing device 130 identifier to the payment processing system 140 via the network 120.

In block 515, the payment processing system 140 receives the transaction details, the transaction identifier, and the merchant computing device 130 identifier. For example, the payment processing system 140 receives the transaction details, the transaction identifier, and the merchant computing device 130 identifier via the network 120. For example, the transaction identifier is a random number generated by the merchant computing device 130 and transmitted along with the merchant computing device 130 identifier and transaction details comprising the total amount of the transaction for the one or more items being purchased by the user 101. In an example embodiment, the payment processing system 140 identifies a merchant system account identifier associated with the merchant system based on the merchant computing device 130 identifier. For example, the payment processing system 140, at the time the merchant system creates an account with the payment processing system 140, associates the merchant computing device 130 identifier with an account identifier associated with the merchant system account and stores the association of the merchant system account identifier and the merchant computing device 130 identifier in a database or data storage unit 146 accessible to the payment processing system 140. In this example, upon receiving the merchant computing device 130 identifier, the transaction details, and the transaction identifier, the payment processing system 140 determines the merchant system account identifier by accessing the database and extracting the merchant system account identifier associated with the merchant computing device 130 identifier. In an example embodiment, the payment processing system 140 stores the transaction identifier, the merchant system account identifier, and the transaction details in a database or in the data storage unit 146 accessible to the payment processing system 140. In this example embodiment, the payment processing system 140 may associate the transaction identifier with the merchant system account identifier and the transaction details, for example, by storing the data in a table or other format.

In block 520, the user 101 taps the user computing device 110 to the merchant computing device 130. In an example embodiment, the user 101 moves the user computing device 110 to within a threshold proximity of the merchant computing device 130 and in such an orientation that the proximity sensor component 114 of the user computing device 110 detects the presence of the merchant computing device 130 and the proximity sensor component 134 of the merchant computing device 130 detects the presence of the user computing device 110. In an example embodiment, the proximity sensors components 114 and 134 are able only to detect objects that are oriented toward the side of the user computing device 110 or merchant computing device 130 in common with the user interface 111 or 131. For example, the proximity sensor component 114 of the user computing device 110 is able to detect an object facing the user interface 111 of the user computing device 110 but is not able to detect an object opposite or otherwise not facing the user interface 111 of the user computing device 110. For example, the proximity sensor component 134 of the merchant computing device 130 is able to detect an object facing the user interface 131 of the merchant computing device 130 but is not able to detect an object opposite or otherwise not facing the user interface 131 of the merchant computing device 130. In an example, the user computing device 110 and/or the merchant computing device 130 comprise smartphone devices or tablet devices with proximity sensors that detect objects facing the user interface 111 or 131 of the respective device. In an example embodiment, in which the proximity sensor components 114 and 134 detect objects facing only the user interface 111 and 131 of the user computing device 110 and the merchant computing device 130, respectively, the user 101 must orient the devices during the tap such that the user interface 111 of the user computing device and the user interface 131 of the merchant computing device 130 are facing within the threshold proximity. For example, the threshold proximity comprises two inches. In other example embodiments, the merchant computing device operator 102 taps the merchant computing device 130 to the user computing device 110. In certain example embodiments, the merchant computing device 130 or second user computing device does not comprise a proximity sensor component 134.

In block 525, the merchant computing device 130 either detects the user computing device 110 or does not detect the user computing device 110 via proximity sensing. In certain example embodiments, the merchant computing device 130 or second user computing device does not comprise a proximity sensor component 134 and the method proceeds to block 535.

Returning to block 525, if the merchant computing device 130 does not detect the user computing device 110 via proximity sensing, the method 240a proceeds to block 530. For example, the user 101 may tap the user computing device 110 to the merchant computing device 130 but not orient the user computing device 110 correctly during the tap such that the proximity sensor component 134 of the merchant computing device 130 may detect the presence of the user computing device 110. In this example, the proximity sensor component 134 of the merchant computing device 130 does not detect an object.

In block 530, the merchant computing device 130 cancels the transaction after a threshold length of time passes. In an example embodiment, the payment application 133 of the merchant computing device 130 logs a first time stamp at the time when merchant computing device operator 102 selects the payment application 133 to initiate a transaction. For example, the payment application 133 cancels the transaction if the payment application 133 receives the alert from the proximity sensor component 134 after a threshold length of time from when the merchant computing device operator 102 initiated the transaction by selecting the payment application 133. For example, the merchant computing device 130 logged the first timestamp when the merchant computing device operator 102 selected the payment application 133 via the user interface 131 of the merchant computing device 130. In an example embodiment, the threshold length of time comprises ten seconds or another appropriate length of time. For example, canceling the transaction comprises deleting the transaction details and/or displaying a message, via the user interface 131 of the merchant computing device 130, stating that the transaction could not be completed.

Returning to block 525, if the merchant computing device 130 detects the user computing device 110 via proximity sensing, the method 240a proceeds to block 540. For example, the user 101 taps the user computing device 110 to the merchant computing device 130. In this example, the proximity sensor component 134 detects the user computing device 110 and transmits an alert to the payment application 133 that an object was detected by the proximity sensor component 134. In an example embodiment, the payment application 133 receives the alert from the proximity sensor component 134 indicating that the proximity sensor component 134 detected an object.

In block 535, the merchant computing device 130 broadcasts an audio token comprising the transaction identifier and the merchant computing device 130 identifier. In an example embodiment, in response to receiving the alert from the proximity sensor component 134 indicating that the proximity sensor component 134 detected an object, the merchant computing device 130 broadcasts the audio token comprising the transaction identifier. Broadcasting the audio token may comprise broadcasting the audio token via ultrasound communication or audible sound communication. For example, as previously discussed, the merchant computing device 130 previously transmitted the transaction identifier along with transaction details to the payment processing system 140. In an example embodiment, the merchant computing device 130 broadcasts the audio token via ultrasound communication. In certain other example embodiments, the merchant computing device 130 does not broadcast the audio token but instead broadcasts a token comprising the transaction identifier via Wi-Fi communication, Bluetooth communication, Bluetooth low-energy communication, light or optical communication, or other appropriate means of communication. In an example embodiment, the merchant computing device 130 continues to broadcast the audio token, Wi-Fi token, Bluetooth token, Bluetooth low-energy token, light or optical token, or other token for a threshold length of time and ceases to broadcast the audio token after the threshold length of time has passed. In an example, the threshold length of time comprises ten seconds or another appropriate length of time. In an example embodiment, the token does not comprise a transaction identifier but instead comprises other data such as files, images, text, applications, or other data. In certain other example embodiments, the merchant computing device 130 or second computing device does not comprise a proximity sensor 134 and does not broadcast the token or audio token in response to receiving an alert from a proximity sensor 134. In these other example embodiments, the merchant computing device 130 or second computing device broadcasts the token or audio token in response to receiving an input via the user interface 131. For example, the input comprises a selection, via the user interface 131 by the operator of the merchant computing device 130 of an option to initiate a transaction or to initiate a transfer of data.

In block 540, the user computing device 110 either detects or does not detect the merchant computing device 130 via proximity sensing.

If the user computing device 110 does not detect the merchant computing device 130 via proximity sensing, the method 240a proceeds to block 550. For example, the user 101 may tap the user computing device 110 to the merchant computing device 130 but not orient the user computing device 110 correctly during the tap such that the proximity sensor component 114 of the user computing device 110 may detect the presence of the merchant computing device 130. In this example, the proximity sensor component 114 of the user computing device 110 does not detect an object.

In block 550, the user computing device 110 cancels the transaction after a threshold length of time passes. In certain example embodiments, the user 101 selects the payment application 113 of the user computing device 110 to initiate a transaction and the user computing device 110 logs a first timestamp at the time the user 101 selects the payment application 113. In an example embodiment, the payment application 113 of the user computing device 110 logs a first time stamp at the time when the user 101 selects the payment application 113 to initiate a transaction. For example, the payment application 113 cancels the transaction if the payment application 113 receives the alert from the proximity sensor component 114 after a threshold length of time from when the user 101 initiated the transaction by selecting the payment application 113. For example, the user computing device 110 logged the first timestamp when the user 101 selected the payment application 113 via the user interface 111 of the user computing device 110. In an example embodiment, the threshold length of time comprises ten seconds or another appropriate length of time after the time logged in the first timestamp. For example, canceling the transaction comprises deleting the transaction details and/or displaying a message, via the user interface 111 of the user computing device 110, stating that the transaction could not be completed.

Returning to block 540, if the user computing device 110 detects the merchant computing device 130 via proximity sensing, the method 240a proceeds to block 560. For example, the user 101 taps the user computing device 110 to the merchant computing device 130. In this example, the proximity sensor component 114 of the user computing device 110 detects the merchant computing device 130 and transmits an alert to the payment application 113 that an object was detected by the proximity sensor component 114. In an example embodiment, the payment application 113 receives the alert from the proximity sensor component 114 indicating that the proximity sensor component 114 detected an object.

In block 560, the user computing device 110 activates a microphone component 119. In an example embodiment, in response to receiving the alert from the proximity sensor component 114 indicating that the proximity sensor component 114 detected an object, the user computing device 110 activates the microphone component 119 to listen for an audio token broadcast by the merchant computing device 130. In another example embodiment, in response to receiving the alert from the proximity sensor component 114 within the threshold length of time from a time at which the user 101 selected the payment application 113 to initiate the transaction indicating that the proximity sensor component 114 detected an object, the user computing device 110 activates the microphone component 119 to listen for an audio token broadcast by the merchant computing device 130. In an example embodiment, the user computing device 110 logs a second timestamp at the time the user computing device 110 activates the microphone component 119 and instructs the microphone component 119 to listen for audio tokens until a predefined threshold length of time passes from the time indicated on the second timestamp. In an example, after the threshold length of time passes, the user computing device 110 deactivates the microphone component 119 or otherwise instructs the microphone component 119 to cease listening for audio tokens broadcast by the merchant computing device 130. In another example embodiment, the user computing device 110, in response to receiving the alert from the proximity sensor component 114 indicating that the proximity sensor component 114 detected an object, activates a component of the user computing device 110 able to receive the token broadcast by the merchant computing device 130 over the communication medium utilized by the merchant computing device 130 to broadcast the token. For example, the user computing device 130 activates a Wi-Fi controller, a Bluetooth controller, Bluetooth low-energy controller, a component to receive light or optical communication, or other component capable of receiving the token over the same transfer medium used by the merchant computing device 130 to broadcast the token. In certain example embodiments, in response to receiving the alert from the proximity sensor component 114, the user computing device 110 opens or otherwise activates the payment application 113, which communicates with appropriate component of the user computing device 110 capable of receiving the token over the same transfer medium used by the merchant computing device 130 to broadcast the token.

In block 570, the user computing device 110 receives the audio token comprising the transaction identifier. For example, the microphone component 119 receives the audio token broadcast by the merchant computing device via ultrasound communication or audible sound communication and transmits the received audio token to the payment application 113 of the user computing device 110. In an example, the payment application 113 extracts the transaction identifier from the received audio token. In another example embodiment, the user computing device 110 receives the token broadcast by the merchant computing device 130 via Bluetooth communication, via Bluetooth low-energy communication, via Wi-Fi communication, via light or optical communication, or via other appropriate transfer medium. In this example embodiment, the user computing device 110 receives the token broadcast by the merchant computing device 130 over a particular transfer medium via an activated component of the user computing device 110 capable of receiving data over the particular transfer medium.

In certain example embodiments, in response to receiving the alert from the proximity sensor component 114 and in response to receiving the token from the merchant computing device 130, the user computing device 110 opens or otherwise activates the payment application 113 on the user computing device 110. In this example embodiment, the payment application 113 displays a request to approve a transaction. An example request to approve a transaction comprises transaction details received via the token broadcast from the merchant computing device 130. In an example embodiment, the request to approve the transaction may comprise one or more objects on the user interface 111 that a user 101 may select to indicate approval or denial of the request to approve the transaction. In an example, the user 101 selects, via the user interface 111, a user interface 111 object to indicate approval of the request to approve the transaction and the user computing device 110 receives the indication of the user 101 approval of the transaction. In another example, the user 101 selects, via the user interface 111, a user interface 111 object to indicate denial of the request to approve the transaction and the user computing device 110 receives an input of an indication of the user 101 denial of the transaction.

In block 580, the user computing device 110 communicates the transaction identifier to the payment processing system 140. For example, the payment application 113 transmits the transaction identifier to the payment processing system 140 via the network 120. In an example, the payment application 113 also transmits a user 101 account identifier for an account associated with the user 101 account maintained by the payment processing system 140 or transmits a user computing device 110 identifier associated with the user computing device 110. In this example, the user 101 account is associated with the user computing device 110 identifier.

In block 590, the payment processing system 140 communicates with the user computing device 110 and processes a transaction. In an example embodiment, the payment processing system 140 identifies the user 101 account based on the received user computing device 110 identifier or the received user 101 account identifier. In an example embodiment, the payment processing system 140 identifies transaction details and a merchant system account based on the received transaction identifier. In an example embodiment, the payment processing system 140 extracts the merchant system account identifier and the transaction details associated with the transaction identifier from a database or in the data storage unit 146 accessible to the payment processing system 140. In an example, the payment processing system 140 identifies the total amount of transaction from the transaction details and identifies a merchant system payment account associated with the merchant system account. In an example embodiment, the payment processing system 140 identifies a user 101 payment account from the user 101 account. For example, the user 101 preconfigured a payment account to be used in transactions. In another example embodiment, the payment processing system 140 identifies two or more user 101 payment accounts from the user 101 account and transmits payment account information associated with the two or more user 101 payment accounts to the user computing device 110 via the network 120 along with a request for the user 101 to select a particular payment account for use in the transaction. In this example embodiment, the user computing device 110 receives the payment account information and the request to select a particular payment account and displays information associated with the two or more payment accounts to the user 101 and provides two or more objects on the user interface 111 enabling the user 101 to select a particular payment account for use in the transaction, each payment account associated with a respective user interface 111 object. In this example embodiment, the user 101 selects a particular user interface 111 object associated with a particular payment account of the user 101 and the user computing device 110 transmits an indication via the network 120 of the user 101 selection of the particular user interface 111 object. To the payment processing system 140 In this example embodiment, the payment processing system 140 receives the indication of the user 101 selection of the particular payment account.

In an example embodiment, the payment processing system 140 generates a transaction authorization request and transmits, via the network 120, the transaction authorization request to an issuer system 150 associated with the payment account selected by the user 101 or the payment account extracted from the user 101 account and preconfigured for use in transactions by the user 101. In an example embodiment, the transaction authorization request includes the total amount of the transaction associated with the transaction identifier, the merchant system payment account identifier associated with the transaction identifier, and a user 101 payment account identifier associated with the user 101 payment account selected by the user 101 or preconfigured for use by the user 101 in transactions. In an example embodiment, the issuer system 150 receives the transaction authorization request via the network 120 and either approves or denies the transaction authorization request. In an example embodiment, the issuer system 150 approves the transaction authorization request and transmits a notice of approval of the transaction authorization request or a notice of denial of the transaction authorization request to the payment processing system 140 in accordance with approving or denying the transaction authorization request. In an example embodiment, the payment processing system 140 receives a notice of approval of the transaction authorization request from the issuer system 150 and transmits a receipt, via the network 120, to the user computing device 110 and/or the merchant computing device 130 indicating that the transaction was successfully completed and comprising the transaction details, information associated with the merchant system payment account used in the transaction, and/or information associated with the user 101 payment account used in the transaction. In another example embodiment, the payment processing system 140 receives a notice of denial of the transaction authorization request from the issuer system 150 and transmits a receipt, via the network 120, to the user computing device and/or to the merchant computing device 130 indicating that the transaction authorization was denied. In an example embodiment, the user computing device 110 receives, via the network 120, the receipt information indicating a transaction authorization request approval or a transaction authorization request denial and displays all or part of the receipt information via the user interface 111 of the user computing device. In an example embodiment, the merchant computing device 130 receives, via the network 120, the receipt information indicating a transaction authorization request approval or a transaction authorization request denial and displays all or part of the receipt information via the user interface 131 of the merchant computing device 130

FIG. 6 is a block diagram depicting a method 240b for pairing a user computing device 110 to a merchant computing device 130 to process a payment transaction, in accordance with certain example embodiments. The method 240b is described with reference to the components illustrated in FIG. 1.

In block 610, the merchant computing device operator 102 selects the payment application 133 on the merchant computing device 130 to initiate a transaction. In an example embodiment, in response to receiving a verbal request from the user 101 to select the payment application 133 as a payment option, the merchant computing device operator 102 actuates an object on the user interface 131 of the merchant computing device 130 corresponding to the payment application 133 as a payment option.

In block 620, the user 101 taps the user computing device 110 to the merchant computing device 130. In an example embodiment, the user 101 moves the user computing device 110 to within a threshold proximity of the merchant computing device 130 and in such an orientation that the proximity sensor component 114 of the user computing device 110 detects the presence of the merchant computing device 130 and the proximity sensor component 134 of the merchant computing device 130 detects the presence of the user computing device 110. In an example embodiment, the proximity sensors components 114 and 134 are able only to detect objects that are oriented toward the side of the user computing device 110 or merchant computing device 130 in common with the user interface 111 or 131. For example, the proximity sensor component 114 of the user computing device 110 is able to detect an object facing the user interface 111 of the user computing device 110 but is not able to detect an object opposite or otherwise not facing the user interface 111 of the user computing device 110. For example, the proximity sensor component 134 of the merchant computing device 130 is able to detect an object facing the user interface 131 of the merchant computing device 130 but is not able to detect an object opposite or otherwise not facing the user interface 131 of the merchant computing device 130. In an example, the user computing device 110 and/or the merchant computing device 130 comprise smartphone devices or tablet devices with proximity sensors that detect objects facing the user interface 111 or 131 of the respective device. In an example embodiment, in which the proximity sensor components 114 and 134 detect objects facing only the user interface 111 and 131 of the user computing device 110 and the merchant computing device 130, respectively, the user 101 must orient the devices during the tap such that the user interface 111 of the user computing device and the user interface 131 of the merchant computing device 130 are facing within the threshold proximity. For example, the threshold proximity comprises two inches. In other example embodiments, the merchant computing device operator 102 taps the merchant computing device 130 to the user computing device 110. In certain example embodiments, the merchant computing device 130 or second user computing device does not comprise a proximity sensor component 134.

In block 625, the merchant computing device 130 either detects the user computing device 110 or does not detect the user computing device 110 via proximity sensing. In certain other example embodiments, the merchant computing device 130 does not comprise a proximity sensor component 134 and cannot detect the user computing device 130. In these other example embodiments, the method proceeds to block 635.

Returning to block 625, if the merchant computing device 130 does not detect the user computing device 110 via proximity sensing, the method 240b proceeds to block 630. For example, the user 101 may tap the user computing device 110 to the merchant computing device 130 but not orient the user computing device 110 correctly during the tap such that the proximity sensor component 134 of the merchant computing device 130 may detect the presence of the user computing device 110. In this example, the proximity sensor component 134 of the merchant computing device 130 does not detect an object.

In block 630, the merchant computing device 130 cancels the transaction after a threshold length of time passes. In an example embodiment, the payment application 133 of the merchant computing device 130 logs a first time stamp at the time when merchant computing device operator 102 selects the payment application 133 to initiate a transaction. For example, the payment application 133 cancels the transaction if the payment application 133 receives the alert from the proximity sensor component 134 after a threshold length of time from when the merchant computing device operator 102 initiated the transaction by selecting the payment application 133. For example, the merchant computing device 130 logged the first timestamp when the merchant computing device operator 102 selected the payment application 133 via the user interface 131 of the merchant computing device 130. In an example embodiment, the threshold length of time comprises ten seconds or another appropriate length of time. For example, canceling the transaction comprises deleting the transaction details and/or displaying a message, via the user interface 131 of the merchant computing device 130, stating that the transaction could not be completed.

Returning to block 625, if the merchant computing device 130 detects the user computing device 110 via proximity sensing, the method 240b proceeds to block 640. For example, the user 101 taps the user computing device 110 to the merchant computing device 130. In this example, the proximity sensor component 134 detects the user computing device 110 and transmits an alert to the payment application 133 that an object was detected by the proximity sensor component 134. In an example embodiment, the payment application 133 receives the alert from the proximity sensor component 134 indicating that the proximity sensor component 134 detected an object.

In block 635, the merchant computing device 130 broadcasts an audio token comprising the transaction identifier and the merchant computing device 130 identifier. In an example embodiment, in response to receiving the alert from the proximity sensor component 134 indicating that the proximity sensor component 134 detected an object, the merchant computing device 130 broadcasts the audio token comprising the transaction identifier and the merchant computing device 130 identifier. In an example embodiment, the merchant computing device 130 broadcasts the audio token via ultrasound communication or audible sound communication. In certain other example embodiments, the merchant computing device 130 does not broadcast the audio token but instead broadcasts a token comprising the transaction identifier and the merchant computing device 130 identifier via Wi-Fi communication, Bluetooth communication, Bluetooth low-energy communication, light or optical communication, or other appropriate means of communication. In an example embodiment, the merchant computing device 130 continues to broadcast the audio token Wi-Fi token, Bluetooth token, Bluetooth low-energy token, light or optical token, or other token for a threshold length of time and ceases to broadcast the token after the threshold length of time has passed. In an example, the threshold length of time comprises ten seconds or another appropriate length of time. In an example embodiment, the token does not comprise a transaction identifier or merchant computing device 130 identifier but instead comprises other data such as files, images, text, applications, or other data. In certain other example embodiments, the merchant computing device 130 or second computing device does not comprise a proximity sensor 134 and does not broadcast the token or audio token in response to receiving an alert from a proximity sensor 134. In these other example embodiments, the merchant computing device 130 or second computing device broadcasts the token or audio token in response to receiving an input via the user interface 131. For example, the input comprises a selection, via the user interface 131 by the operator of the merchant computing device 130 of an option to initiate a transaction or to initiate a transfer of data.

In block 640, the user computing device 110 either detects or does not detect the merchant computing device 130 via proximity sensing.

If the user computing device 110 does not detect the merchant computing device 130 via proximity sensing, the method 240b proceeds to block 645. For example, the user 101 may tap the user computing device 110 to the merchant computing device 130 but not orient the user computing device 110 correctly during the tap such that the proximity sensor component 114 of the user computing device 110 may detect the presence of the merchant computing device 130. In this example, the proximity sensor component 114 of the user computing device 110 does not detect an object.

In block 645, the user computing device 110 cancels the transaction after a threshold length of time passes. In certain example embodiments, the user 101 selects the payment application 113 of the user computing device 110 to initiate a transaction and the user computing device 110 logs a first timestamp at the time the user 101 selects the payment application 113. In an example embodiment, the payment application 113 of the user computing device 110 logs a first time stamp at the time when the user 101 selects the payment application 113 to initiate a transaction. For example, the payment application 113 cancels the transaction if the payment application 113 receives the alert from the proximity sensor component 114 after a threshold length of time from when the user 101 initiated the transaction by selecting the payment application 113. For example, the user computing device 110 logged the first timestamp when the user 101 selected the payment application 113 via the user interface 111 of the user computing device 110. In an example embodiment, the threshold length of time comprises ten seconds or another appropriate length of time after the time logged in the first timestamp. For example, canceling the transaction comprises deleting the transaction details and/or displaying a message, via the user interface 111 of the user computing device 110, stating that the transaction could not be completed.

Returning to block 640, if the user computing device 110 detects the merchant computing device 130 via proximity sensing, the method 240b proceeds to block 650. For example, the user 101 taps the user computing device 110 to the merchant computing device 130. In this example, the proximity sensor component 114 of the user computing device 110 detects the merchant computing device 130 and transmits an alert to the payment application 113 that an object was detected by the proximity sensor component 114. In an example embodiment, the payment application 113 receives the alert from the proximity sensor component 114 indicating that the proximity sensor component 114 detected an object.

In certain example embodiments, in response to receiving the alert from the proximity sensor component 114 and in response to receiving the token from the merchant computing device 130, the user computing device 110 opens or otherwise activates the payment application 113 on the user computing device 110. In an example, the payment application 113 displays, via the user interface 111, a request to approve transmission of data from the user computing device 110 and/or reception of data from the merchant computing device 130 by the user computing device 110. An example request to approve transmission/receipt of data comprises data received via the token broadcast from the merchant computing device 130. In an example embodiment, the request to approve the transaction may comprise one or more objects on the user interface 111 that a user 101 may select to indicate approval or denial of the request to transmit and/or receive information. In an example, the user 101 selects, via the user interface 111, a user interface 111 object to indicate approval of the request to approve the transmission/reception of data and the user computing device 110 receives the indication of the user 101 approval of the transmission/reception of data. In another example, the user 101 selects, via the user interface 111, a user interface 111 object to indicate denial of the request to approve the transmission/reception of data and the user computing device 110 receives an input of an indication of the user 101 denial of the request to approve transmission/reception of data. In yet another example, the payment application 113 of the first user computing device or other application of the first user computing device displays, via the user interface 111 of the first user computing device, a request to approve transmission of data from the first user computing device and/or reception of data from the second user computing device.

In block 650, the user computing device 110 activates a microphone component 119. In an example embodiment, in response to receiving the alert from the proximity sensor component 114 indicating that the proximity sensor component 114 detected an object, the user computing device 110 activates the microphone component 119 to listen for an audio token broadcast by the merchant computing device 130. In another example embodiment, in response to receiving the alert from the proximity sensor component 114 within the threshold length of time from a time at which the user 101 selected the payment application 113 to initiate the transaction indicating that the proximity sensor component 114 detected an object, the user computing device 110 activates the microphone component 119 to listen for an audio token broadcast by the merchant computing device 130. In an example embodiment, the user computing device 110 logs a second timestamp at the time the user computing device 110 activates the microphone component 119 and instructs the microphone component 119 to listen for audio tokens until a predefined threshold length of time passes from the time indicated on the second timestamp. In an example, after the threshold length of time passes, the user computing device 110 deactivates the microphone component 119 or otherwise instructs the microphone component 119 to cease listening for audio tokens broadcast by the merchant computing device 130. In another example embodiment, the user computing device 110, in response to receiving the alert from the proximity sensor component 114 indicating that the proximity sensor component 114 detected an object, activates a component of the user computing device 110 able to receive the token broadcast by the merchant computing device 130 over the communication medium utilized by the merchant computing device 130 to broadcast the token. For example, the user computing device 130 activates a Wi-Fi controller, a Bluetooth controller, Bluetooth low-energy controller, a component to receive light or optical communication, or other component capable of receiving the token over the same transfer medium used by the merchant computing device to broadcast the token. In an example embodiment, the user computing device 110 activates the microphone component 119 or other component of the user computing device 110 able to receive the token broadcast by the merchant computing device 130 further in response to receiving an input of an indication by the user 101 of an approval to transmit/receive data.

In block 660, the user computing device 110 receives the audio token comprising the transaction details. For example, the microphone component 119 receives the audio token broadcast by the merchant computing device via ultrasound communication or audible sound communication and transmits the received audio token to the payment application 113 of the user computing device 110. In an example, the payment application 113 extracts the transaction identifier from the received audio token. In another example embodiment, the user computing device 110 receives the token broadcast by the merchant computing device 130 via Bluetooth communication, via Bluetooth low-energy communication, via Wi-Fi communication, via light or optical communication, or via other appropriate transfer medium. In this example embodiment, the user computing device 110 receives the token broadcast by the merchant computing device 130 over a particular transfer medium via an activated component of the user computing device 110 capable of receiving data over the particular transfer medium.

In block 670, the user computing device 110 and the merchant computing device 130 establish a network 120 connection. For example, the user computing device 110, in response to receiving the audio token comprising the transaction details, transmits a request, via ultrasound communication or other appropriate communication protocol, a request to establish a network 120 connection with the merchant computing device 130. In this example, the merchant computing device 130 receives the request to establish the network 120 connection and transmits a response to the user computing device 110 approving the request to establish a network 120 connection. In an example embodiment, the user computing device 110 and the merchant computing device 130 may exchange cryptographic keys to enable encrypted communication. In an example embodiment, the merchant computing device 130 and the user computing device 110 establish a Wi-Fi network 120 connection, a Bluetooth network connection, a Bluetooth low-energy network connection, a light or optical network connection, an ultrasound network connection, an audio communication network, an ultrasound communication network, or other appropriate network 120 connection between the devices. In other example embodiments, the user computing device 110 and the merchant computing device 130 do not establish a network 120 connection and communicate via ultrasound or audible sound communication or via the same transfer medium used to transmit the token from the merchant computing device 130 to the user computing device 110.

In block 680, the merchant computing device 130 transmits a request for payment account information to the user computing device 110. For example, the merchant computing device 130 transmits the request for payment account information to the user computing device 110 via the network 120 communication channel established between the devices or transmits the request for payment account information via an audio token via ultrasound communication. In this example, the user computing device 110 receives the request for payment account information via the network 120 communication channel established between the devices or otherwise receives the request for payment information via an audio token via ultrasound communication. In another example, the merchant computing device 130 transmits data to the user computing device 110. For example, the merchant computing device 130 transmits images, text, files, or other data selected by the merchant computing device operator to the user computing device 110. In this example, in response to establishing a network connection between the user computing device 110, the merchant computing device 130 displays a request to select data for transmission to the user computing device 110. For example, the merchant computing device 130 may display a menu of user interface 131 objects associated with one or more images, files, text, or other data selectable by the operator of the merchant computing device 130 that enable the operator to indicate one or more data items the operator wishes to transmit to the user computing device 110. In this example, the merchant computing device 130 operator selects one or more of the user interface 131 objects and the merchant computing device 130 receives an indication of the selection of the one or more user interface 131 objects indicating one or more corresponding data items the operator wishes to transmit to the user computing device 110. In another example embodiment, the user computing device 110 receives, from the merchant computing device 130, one or more data items selected by the user 101 for transmission by the merchant computing device 130 to the user computing device 110. For example, the one or more data items comprise one or more of images, documents, files, text, or other data items.

In yet another example, the merchant computing device 130 transmits a request for data to the user computing device 110. For example, the merchant computing device 130 transmits a request for data comprising a request for the user 101 to select one or more data comprising one or more of images, documents, files, text, or other data for transmission from the user computing device 110 to the merchant computing device 130.

In block 690, the merchant computing device 130 receives the payment account information from the user computing device 110. In an example embodiment, the user computing device 110 displays the request for payment account information via the user interface 111 of the user computing device 110. In an example embodiment, the user computing device 110 displays, via the user interface 111, payment account information corresponding to a payment account of the user 101 preconfigured for use in transactions and displays a first user interface 111 object representing an option to accept the use of the preconfigured payment account information in the transaction and a second user interface 111 object representing an option to reject the use of the preconfigured payment account information in the transaction. In an example embodiment, the user 101 selects the user interface 111 object indicating acceptance of the use of the preconfigured payment account information in the transaction. In this example embodiment, the user computing device 110 transmits an indication of the user 101 selection to accept the use of the preconfigured payment account information to the merchant computing device 130 via the network 120 communication channel established between the user computing device 110 and the merchant computing device 130 or otherwise via a sound token. In an example embodiment, the merchant computing device 130 receives the indication of the user 101 selection to accept the use of the preconfigured payment account information in the transaction.

In another example embodiment, the user computing device 110 displays via the user interface 111, two or more payment account options associated with two or more corresponding payment accounts of the user 101 that are available for use in the transaction and associated with the user 101 account with the payment processing system 140. In this example embodiment, the user computing device 110 displays, via the user interface 111, two or more user interface 111 objects corresponding to options to select any one of the two or more payment accounts of the user 101 for use in the transaction. In this example embodiment, the user 101 selects a particular user interface 111 object via the user interface 111 corresponding to a particular payment account that the user 101 desires to use in the transaction. In an example embodiment, the user computing device 110 transmits an indication of the selection of the particular payment account to the merchant computing device 130 and a payment account identifier associated with the selection. In another example embodiment, the user computing device 110 transmits a payment account number and payment account information associated with the user 101 selection of the particular payment account sufficient for the merchant computing device 130 to process a transaction. For example, the user computing device 110 may transmit the payment account number, an expiration date, a billing address, a billing zip code, and/or other payment account information associated with the payment account. In this example, the user 101 may manually enter one or more payment account information such as a card verification code (“CVV”) or a personal identification number (“PIN”) via the user interface 111 to transmit along with the user's 101 stored payment account information. In yet another example embodiment, the user 101 manually enters payment account information into the user interface 111 to transmit to the merchant computing device 130.

In yet another example embodiment, the user computing device 110 receives, from the merchant computing device 130, a request for data. In this example embodiment, the user computing device 110 displays a request to select data for transmission to the merchant computing device 130. For example, the user computing device 110 may display a menu of user interface 111 objects associated with one or more images, files, text, or other data selectable by the user 101 that enable the user 101 to indicate one or more data items the user 101 wishes to transmit to the merchant computing device 130. In this example, the user 101 selects one or more of the user interface 111 objects and the user computing device 110 receives an indication of the selection of the one or more user interface 111 objects indicating one or more corresponding data items the user 101 wishes to transmit to the merchant computing device 130. In an example embodiment, in response to receiving a n indication of the selection of the one or user interface 111 objects indicating one or more corresponding data items, the user computing device 110 transmits the selected one or more corresponding data items to the merchant computing device 130. In this example embodiment, the merchant computing device 130 receives the one or more corresponding data items from the user computing device 110. In an example embodiment, the user computing device 110 transmits the selected corresponding data items to the merchant computing device 130 via a proximity network connection between the user computing device 110 and the merchant computing device 130. In another example embodiment, the user computing device 110 transmits the indicated of the selection of the corresponding data items to the payment processing system 140 via the network 120, the payment processing system 140 extracts information associated with the selected corresponding data items, and the payment processing system 140 transmits the extracted information associated with the selected corresponding data items to the merchant computing device 130 via the network 120.

In block 695, the merchant computing device 130 processes the transaction based on the transaction details and the receives payment account information. In an example embodiment, the merchant computing device 130 processes the transaction using payment information received from the user computing device 110 via the network 120 communication channel established between the user computing device 110 and the merchant computing device 130. In this example embodiment, the merchant computing device generates a transaction authorization request comprising a total amount of the transaction, payment account information of the user, and payment account information of the merchant system and transmits, via the network 120, the transaction authorization request to an issuer system 150 associated with the user's 101 selected payment account or to an issuer system 150 associated with the payment account information provided by the user 101 for use in the transaction. In an example embodiment, the issuer system 150 receives the transaction authorization request over the network 120 and approves or denies the transaction authorization request. The issuer system 150 may transmit, over the network 120, a notice or denial of the transaction authorization request to the merchant computing device 130. The merchant computing device 130 may receive, over the network 120, the approval or denial of the transaction authorization request from the issuer system 150. In an example embodiment, the merchant computing device 130 displays a receipt via the user interface 131 of the merchant computing device 130 and/or transmits a receipt to the user computing device 110 via the network 120 communication channel between the merchant computing device 130 and the user computing device 110. For example, the receipt displays information in accordance with the approval or denial of the transaction authorization request. For example, if the transaction authorization request was approved, the receipt may show a listing of items purchased, a total price of the purchase, account information of the user, and/or any other relevant information concerning the completed transaction. In another example, if the transaction authorization request was denied, the receipt may show a notice that the transaction was declined.

In another example embodiment, the merchant computing device 130 provides a payment account identifier received from the user computing device 110 and retransmits the payment account identifier along with the transaction details and the merchant computing device 130 identifier. In this example embodiment, the payment processing system 140 processes the transaction. The payment processing system 140 may determine user 101 payment account information associated with the received user 101 payment account identifier. For example, the user 101 payment account identifier identifies a particular payment account in a user 101 account managed by the payment processing system 140 and comprising the user 101 payment account information. The payment processing system 140 may determine merchant system payment account information associated with the received merchant computing device 130 identifier. For example, the merchant computing device 130 identifier identifies a merchant system account managed by the payment processing system 140 and comprising the merchant system payment account information. In this example embodiment, the payment processing system 140 generates a transaction authorization request comprising a total amount of the transaction derived from the transaction details received from the merchant computing device 130, payment account information of the user, and payment account information of the merchant system. In this example embodiment, the payment processing system 140 transmits, via the network 120, the transaction authorization request to an issuer system 150 associated with the user's 101 selected payment account or to an issuer system 150 associated with the payment account information provided by the user 101 for use in the transaction. In an example embodiment, the issuer system 150 receives the transaction authorization request over the network 120 and approves or denies the transaction authorization request. The issuer system 150 may transmit, over the network 120, a notice or denial of the transaction authorization request to the payment processing system 140, which forwards the notice to the merchant computing device 130 and/or the user computing device 110. The merchant computing device 130 and/or the user computing device 110 may receive, over the network 120, the approval or denial of the transaction authorization request from the issuer system 150. In an example embodiment, the merchant computing device 130 displays a receipt via the user interface 131 of the merchant computing device 130 and/or transmits a receipt to the user computing device 110 via the network 120 communication channel between the merchant computing device 130 and the user computing device 110. For example, the receipt displays information in accordance with the approval or denial of the transaction authorization request. For example, if the transaction authorization request was approved, the receipt may show a listing of items purchased, a total price of the purchase, account information of the user, and/or any other relevant information concerning the completed transaction. In another example, if the transaction authorization request was denied, the receipt may show a notice that the transaction was declined.

### Other Example Embodiments

FIG. 7 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a router or other network node, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to certain example embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to pair computing devices via proximity sensing, comprising:
detecting, by a proximity sensor of a first user computing device, an object, wherein the proximity sensor detects the object in response to placement of the first user computing device in proximity with a second user computing device;
in response to detecting the object, transmitting, a token via an audio component of the first user computing device;
detecting, by a proximity sensor of the second user computing device, another object, wherein the proximity sensor detects the another object in response to the placement of the first user computing device in proximity with the second user computing device;
in response to detecting the object, activating, by the second user computing device, a microphone component associated with the second user computing device to receive the token from the first user computing device; and
in response to receiving the token from the first user computing device, transmitting, by the second user computing device data.

2. The method of claim 1, further comprising:
receiving, by the first user computing device, an input of a selection of an application; and
activating, by the first user computing device, the proximity sensor component of the first user computing device in response to receiving the input of the selection of the application.

3. The method of claim 1, wherein the first user computing device transmits the token to the second user computing device via ultrasound communication.

4. The method of claim 1, wherein the second user computing device transmits the data to the first user computing device via ultrasound communication.

5. The method of claim 1, wherein the data comprise one or more of files, images, and text stored on the second user computing device.

6. The method of claim 1, wherein the data comprise payment account information.

7. The method of claim 6, further comprising:
transmitting, by the first user computing device, a transaction authorization request comprising the payment account information to an issuer system, wherein the issuer system approves or denies the transaction authorization request; and
receiving, by the first user computing device and from the issuer system, a notice of an approval of the transaction authorization request or a notice of a denial of the transaction authorization request.

8. A computer program product, comprising:
a non-transitory computer-readable medium having computer-executable program instructions embodied thereon that when executed by a first user computing device cause the first user computing device to pair computing devices to transmit data via proximity sensing, the computer-executable program instructions comprising:
computer-executable program instructions to detect an object via a proximity sensor of a first user computing device;
computer-executable program instructions to, in response to detecting the object by the first user computing device, transmit a token via a transfer medium;
computer-executable program instructions to detect another object via a proximity sensor of a second user computing device;
computer-executable program instructions to, in response to detecting the another object, receive the token transmitted by the first user computing device via the transfer medium; and
computer-executable program instructions to, in response to receiving the token transmitted by the first user computing device via the transfer medium receive, transmit, by the second user computing device, data based on instructions in the token; and
computer-executable program instructions to receive, by the first user computing device the transmitted data from the second user computing device.

9. The computer program product of claim 8, wherein the transfer medium comprises ultrasound communication, audio communication, Wi-Fi communication, Bluetooth communication, Bluetooth low-energy communication, RF communication, or optical communication.

10. The method of claim 1, wherein the data comprise one or more of files, images, and text stored on the second user computing device.

11. The computer program product of claim 8, wherein the data comprises payment account information.

12. The computer program product of claim 11, further comprising:
computer-executable program instructions to transmit a transaction authorization request comprising the payment account information to an issuer system, wherein the issuer system approves or denies the transaction authorization request; and
computer-executable program instructions to receive, from the issuer system, a notice of an approval of the transaction authorization request or a notice of a denial of the transaction authorization request.

13. The computer program product of claim 8, further comprising:
computer-executable program instructions to receive an input of a selection of an application; and
computer-executable program instructions to activate the proximity sensor component of the first user computing device in response to receiving the input of the selection of the application.

14. The computer program product of claim 8, wherein the data comprise a request to establish a network connection between the second user computing device and the first user computing device and further comprising computer-executable program instructions to communicate with the second user computing device to establish the network connection.

15. A system to pair computing devices to transmit data via proximity sensing, comprising:
a storage device;
a proximity sensor; and
a processor communicatively coupled to the storage device, wherein the processor executes application code instructions that are stored in the storage device to cause the system to:
detect an object via the proximity sensor, wherein the proximity sensor detects the object in response to a placement of the system in proximity with a second user computing device;
in response to detecting the object, transmit a token via an audio component to the second user computing device, wherein the second user computing device detects, by a proximity sensor of the second user computing device, another object, wherein the proximity sensor of the second user computing device detects the another object in response to the placement of the system in proximity with the second user computing device, and wherein in response to detecting the object via the proximity sensor of the second user computing device, the second user computing device activates a microphone component associated with the second user computing device to receive the token;
receive, from the second user computing device, data, wherein the second user computing device transmits the data in response to receiving the token.

16. The system of claim 15, wherein the data comprises payment account information.

17. The system of claim 16, wherein the processor is further configured to execute computer-readable program instructions stored in the storage device to cause the system to:
transmit a transaction authorization request comprising the payment account information to an issuer system, wherein the issuer system approves or denies the transaction authorization request; and
receive, from the issuer system, a notice of an approval of the transaction authorization request or a notice of a denial of the transaction authorization request.

18. The system of claim 15, wherein the processor is further configured to execute computer-readable program instructions to cause the system to:
receive an input of a selection of an application; and
activate the proximity sensor component of the first user computing device in response to receiving the input of the selection of the application.

19. The system of claim 15, wherein the token is transmitted to the second user computing device via ultrasound communication and wherein the data is received from the second user computing device via ultrasound communication.

20. The system of claim 15, wherein the data comprise a request to establish a network connection between the second user computing device and the system and wherein the processor is further configured to execute computer-readable program instructions to cause the system to communicate with the second device to establish a network connection between the system and the second user computing device.
